(19) United States
(12) Patent Application Publication
(10) Pub. No.: US 2024/0160644 A1
(43) Pub. Date: May 16, 2024

(54) METHOD FOR ENHANCED CLASSIFICATION OF RECORDS

(71) Applicant: Eaton Intelligent Power Limited, Dublin 4 (IE)

(72) Inventors: Adi BOTEA, Clonsilla (IE); Mrunalini BADNAKHE, Pune (IN); Chahrazed BOUHINI, Dublin (IE); Archit JAIN, Indore (IN); Leo MUCKLEY, Dublin (IE)

(21) Appl. No.: 18/548,749

(22) PCT Filed: Apr. 22, 2021
(86) PCT No.: PCT/EP2021/060574

§ 371 Date: Sep. 1, 2023

(30) Foreign Application Priority Data
Mar. 6, 2021 (IN) IN202111009434

(51) Int. Cl. G06F 16/28; G06F 16/901

(52) U.S. Cl. CPC G06F 16/285; G06F 16/9024

(57) ABSTRACT

A computer-implemented method for classifying for classifying input record data by relevance to classification options of a classification scheme. The input record data comprising a plurality of input records, each input record comprising one or more record features. The method comprises: receiving a set of relevance scores based on first and second classification techniques, the set of relevance scores comprising pairs of relevance scores, each pair of relevance scores being associated with a respective record feature and a respective classification option and comprising a first relevance score obtained by the first classification technique and a second relevance score obtained by the second classification technique, each of the first and second relevance scores being indicative of a relevance of the respective record feature to the respective classification option; determining one or more ambiguous record features of the record features by comparing the first and second relevance scores.

### TECHNICAL FIELD

The present disclosure relates generally to a method for classifying record features according to a classification scheme. Aspects of the disclosure relate to the method, to a classification system, and to a non-transitory computer-readable storage medium.

### BACKGROUND

It is often desirable to classify recorded data according to a classification scheme in which classification options may be organised into a sparse and deep hierarchical structure, such as a tree or a directed acyclic graph. In this manner, the data may be classified at a desired level of detail and the classified data is searchable and sortable for efficient processing and storage.

Techniques for classifying data records into classification schemes are well-known in the art of computer science, including active learning techniques, for example, that couple machine learning techniques for classifying data records with the ability to query a user. For example, an active learning technique may utilise a machine learning technique trained to classify data records based on historic classifications, or ground truth information, and query a user when necessary (e.g. when new or unrecognised data records are encountered), so that the user can provide user-defined classifications.

However, without a large resource of classified data records/ground truth information, extensive user intervention is generally required, which is time-consuming and expensive. An insufficient resource of classified data records/ground truth information also makes it difficult to assess the performance, or accuracy, of a classification technique, for example during a development phase.

It is against this background that this disclosure has been devised.

### SUMMARY OF THE DISCLOSURE

According to an aspect of the disclosure there is provided a computer-implemented method for classifying input record data by relevance to classification options of a classification scheme. The input record data comprises a plurality of input records, each input record comprising one or more record features. The method comprises: receiving a set of relevance scores based on first and second classification techniques, the set of relevance scores comprising pairs of relevance scores, each pair of relevance scores being associated with a respective record feature and a respective classification option and comprising a first relevance score obtained by the first classification technique and a second relevance score obtained by the second classification technique, each of the first and second relevance scores being indicative of a relevance of the respective record feature to the respective classification option; determining one or more ambiguous record features of the record features by comparing the first and second relevance scores of each pair of relevance scores, wherein it is determined whether each respective record feature is an ambiguous record feature in dependence on a difference between the first and second relevance scores of at least one of the respective pairs of relevance scores associated with that record feature; determining an importance factor associated with each determined ambiguous record feature based on one or more variables indicative of the relative importance of accurately classifying that ambiguous record feature; selecting one or more of the ambiguous record features to output based on their associated importance factors; and outputting the selected ambiguous record features for user-defined classification.

Advantageously, the method provides for a reduction in the extent of user intervention required to classify input record data by comparing the results of a pair of classification techniques and only outputting record features for user-defined classification where the classification techniques disagree, i.e. where the first and second relevance scores differ. As a result, one classification technique is able to corroborate or reject the classification results, or relevance scores, of the other classification technique to effectively share knowledge between the classification techniques, thereby reducing the extent of user-intervention required. The method is therefore able to classify a larger range of input record data with reduced user intervention by only outputting those rejected classification results for user-defined classification.

Example ones of the plurality of input records may, for example, consist of a single record feature describing the subject(s) of that input record, for instance, or an input record may include a plurality of record features, in which case: i) each record feature of the input record may describe a respective subject of the input record; ii) groups of the record features may collectively describe respective subjects of the input record; and/or iii) all of the record features of the input record may collectively describe a subject of the input record. Such subjects, or features thereof, may be represented by respective classification options in the classification scheme and the classification system may therefore be configured to evaluate the relevance of those record features to the classification options of the classification scheme.

For the sake of clarity, it shall be appreciated that the association of each pair of relevance scores with a respective record feature and a respective classification option, means that each pair of relevance scores may be associated with the relevance of: a single respective record feature with reference to a respective classification option; a plurality of respective record features (from an input record) with reference to a respective classification option, for example when the plurality of respective record features are considered in combination; or all of the record features of an input record with reference to a respective classification option. Hence, where all, or a plurality of, record features of an input record collectively describe a respective subject, equivalent pairs of relevance scores may be determined that are associated with each of those record features and the respective classification option; or a single pair of relevance scores may be determined that is associated with each of those record features and the respective classification option. For example, an input record may be received with a pair of relevance scores for a respective classification option and the pair of relevance scores would be associated with the relevance of each record feature of the input record to the respective classification option.

It shall also be appreciated that an importance factor may be associated with a single respective ambiguous record feature or an importance factor may be associated with a plurality of respective record features. Furthermore, the selected ambiguous record features may be selected and output for user-defined classification as individual record features, in suitable combinations, or the input records containing those ambiguous record features may be selected and output for user-defined classification.

Optionally, determining whether each respective record feature is an ambiguous record feature comprises comparing the difference between the first and second relevance scores of at least one of the respective pairs of relevance scores associated with that record feature to an ambiguity threshold. In this manner, the ambiguity threshold may be advantageously used to control the sensitivity of the method to disagreement between the first and second classification techniques. Advantageously, the method may only require user-defined classification for those record features where the difference between the first and second relevance scores of at least one of the respective pairs of relevance scores associated with each of those record features exceeds the ambiguity threshold, for example.

For each importance factor, the one or more variables may include: the respective classification option for each pair of relevance scores that the ambiguous record feature determination depends on; and/or a hierarchical position, within the classification scheme, of that classification option. In this manner, the method can be calibrated for sensitivity to certain classification options. For example, allowing ambiguous record features that are relevant to important classification options to be prioritised and selected for user-defined classification. In an example, for each importance factor, the one or more variables may include: a weighting associated with the respective classification option for each pair of relevance scores that the ambiguous record feature determination depends on; and/or a weighting associated with the hierarchical position, within the classification scheme, of that classification option. Such weightings may be predetermined, for example, and reflect the importance of such classification options.

Optionally, for each importance factor, the one or more variables include: a respective confidence score associated with the first relevance score of each pair of relevance scores that the ambiguous record feature determination depends on; and/or a respective confidence score associated with the second relevance score of each pair of relevance scores that the ambiguous record feature determination depends on. In this manner, the relative confidence in the determined relevance scores can be factored into the selection of the ambiguous record features for user-defined classification.

Optionally, selecting the one or more ambiguous record features to output for user-defined classification comprises: determining a relative ranking of the ambiguous record features based on their associated importance factors; and selecting one or more of the ambiguous record features to output for user-defined classification based on the ranking. In this manner, the ambiguous record features may be ranked and prioritised such that the ambiguous record features with the most potential to improve the classification of the input record data are selected for user-defined classification.

Optionally, selecting the one or more ambiguous record features to output for user-defined classification comprises: determining a plurality of ambiguous data groups, each ambiguous data group comprising related ones of the ambiguous record features; and selecting one or more of the ambiguous data groups to output for user-defined classification based on the importance factors associated with the ambiguous record features of that ambiguous data group. In this manner, the ambiguous record features, or the input records containing said ambiguous record features, may be grouped together based on their similarity and selected as a group for user-defined classification, allowing the user-defined classifications to inform the classification of related ambiguous record features. Hence, the extent of user intervention required may be reduced with this approach.

Optionally, selecting the one or more ambiguous record features to output for user-defined classification further comprises determining a relative ranking of the ambiguous data groups based on the importance factors associated with the ambiguous record features of each ambiguous data group. For example, the relative ranking of the ambiguous data groups may be based, at least in part, on a sum or a weighted sum of the importance factors associated with the ambiguous record features of each ambiguous data group. The selection of the ambiguous data groups to output for user-defined classification may, for example, be based on the ranking. In this manner, the ambiguous data groups may be ranked and prioritised such that the ambiguous data groups with the most potential to improve the classification of the input record data are selected for user-defined classification.

Determining the ambiguous data groups may, for example, comprise: determining a knowledge graph that models the relevance of the one or more ambiguous record features to one another; and applying a clustering technique to the knowledge graph. The knowledge graph may advantageously include relational data indicating relationships between the record features, and/or the input records, which the clustering technique may advantageously utilize to determine the ambiguous data groups.

Optionally, for each importance factor, the one or more variables include a measure of the relative size of the respective ambiguous data group for the respective ambiguous record feature. The measure of the relative size may be determined by counting the number of ambiguous record features or input records in each ambiguous data group, for example. In this manner, the selection of ambiguous record features for user-defined classification can account for the frequency of occurrence of the ambiguous record features, allowing more frequent classification issues to be rectified.

In an example, the method further comprises: receiving a plurality of input records, each input record including one or more record features; and determining the set of relevance scores based on a first classification technique and a second classification technique. In this manner, the method may advantageously include the step of determining the relevance scores for the input records.

In an example, the method further comprises updating the first and/or second classification techniques based on the user-defined classification of the selected one or more ambiguous record features. In this manner, the first and/or second classification techniques may be refined by the user-defined classifications. Hence, advantageously, the method may select ambiguous record features for user-defined classification that are most likely to improve the accuracy or reliability of the first and/or second classification techniques. The first classification technique may be a machine learning technique, for example. In an example, the first classification technique is updated by training the machine learning technique based on the user defined classification of the selected one or more ambiguous record features. In this manner, the method provides for active learning based classification enhancement.

According to another aspect of the disclosure there is provided a non-transitory, computer-readable storage medium having instructions stored thereon that, when executed by a computer, cause the computer to carry out the method described in a previous aspect of the disclosure.

According to a further aspect of the disclosure there is provided a classification system for classifying input record data by relevance to classification options of a classification scheme. The input record data comprising a plurality of input records, each input record comprising one or more record features record features of input records by relevance to classification options of a classification scheme. The classification system comprises: a comparison module configured to: receive a set of relevance scores based on first and second classification techniques, the set of relevance scores comprising pairs of relevance scores, each pair of relevance scores being associated with a respective record feature and a respective classification option and comprising a first relevance score obtained by the first classification technique and a second relevance score obtained by the second classification technique, each of the first and second relevance scores being indicative of the relevance of the respective record feature to the respective classification option; and

determine one or more ambiguous record features of the record features by comparing the first and second relevance scores of each pair of relevance scores, wherein it is determined whether each respective record feature is an ambiguous record feature in dependence on a difference between the first and second relevance scores of at least one of the respective pairs of relevance scores associated with that record feature; a selection module configured to: determine an importance factor associated with each determined ambiguous record feature based on one or more variables indicative of the relative importance of accurately classifying that ambiguous record feature; and select one or more of the ambiguous record features to output based on their determined importance factors; and an output module configured to output the selected ambiguous record features for user-defined classification.

Optionally, the selection module is configured to select the ambiguous record features to output for user-defined classification by: determining a relative ranking of the ambiguous record features based on their associated importance factors; and selecting one or more of the ambiguous record features to output for user-defined classification based on the ranking.

In an example, the selection module may be configured to select the one or more ambiguous record features to output for user-defined classification by: determining a plurality of ambiguous data groups, each ambiguous data group comprising related ones of the ambiguous record features; and selecting one or more of the ambiguous data groups to output for user-defined classification based on the importance factors associated with the ambiguous record features of that ambiguous data group.

Optionally, the selection module is configured to select one or more of the ambiguous data groups to output for user-defined classification by: determining a relative ranking of the ambiguous data groups based on the importance factors associated with the ambiguous record features of each ambiguous data group; and selecting one or more of the ambiguous data groups to output for user-defined classification based on the ranking.

In an example, the classification system further comprises: an input module configured to receive a plurality of input records, each input record comprising one or more record features; and a relevance assessment module configured to determine the set of relevance scores based on a first classification technique and a second classification technique.

In an example, the classification system further comprises a user-interface module configured to receive one or more user inputs and to determine the user-defined classification of each ambiguous record feature received from the output module based on the one or more user inputs.

Optionally, the user-interface module is configured to output the user-defined classification of each ambiguous record feature to the relevance assessment module; and wherein the relevance assessment module is configured to update the first and/or second classification technique based on the user-defined classification of each ambiguous record feature.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 is a schematic illustration showing an example classification system in accordance with an embodiment of the disclosure;

FIG. 2 is a schematic illustration showing an example method of operating the classification system, shown in FIG. 1, in accordance with an embodiment of the disclosure;

FIG. 3 is a schematic illustration showing example sub-steps of the method shown in FIG. 2;

FIG. 4 is a schematic illustration showing further example sub-steps of the method shown in FIG. 2;

FIG. 5 is a schematic illustration showing alternative example sub-steps of the method shown in FIG. 2; and

FIG. 6 is a schematic illustration showing another example method of operating the classification system, shown in FIG. 1, in accordance with an embodiment of the disclosure.

### DETAILED DESCRIPTION

Embodiments of the disclosure relate to a classification system, and to a method, for classifying input record data (i.e. input records, and the record features thereof) according to a classification scheme, such as a hierarchical structure.

The classification system is configured to receive one or more input records and to evaluate the relevance of the record feature(s) of each input record to classification options of the classification scheme. For example, each input record may include one or more record features describing one or more subjects of that input record, such as an object, event, or transaction, for example. For example, an input record may consist of a single record feature describing the subject(s) of that input record, for instance, or an input record may include a plurality of record features, in which case: i) each record feature of the input record may describe a respective subject of the input record; ii) groups of the record features may collectively describe respective subjects of the input record; and/or iii) all of the record features of the input record may collectively describe a subject of the input record. Such subjects, or features thereof, may be represented by respective classification options in the classification scheme and the classification system may therefore be configured to evaluate the relevance of those record features to the classification options of the classification scheme.

Advantageously, the classification system is configured to evaluate the relevance of the record features to the classification options using multiple classification techniques and thereby to identify instances where two distinct classification techniques disagree on the relevance of a respective record feature to a respective classification option. If the ground truth about a given record is unique, and two classification techniques disagree with each other, then at least one of them must be wrong.

Accordingly, such record features are flagged as ambiguous record features that demonstrate limitations of at least one of the classification techniques. This approach provides a powerful tool for pinpointing ambiguous record features that warrant user intervention and the classification system makes use of this information to select certain record features to output for user defined classification. In this manner, the classification system addresses the problem of evaluating the performance, or accuracy, of a classification technique where limited ground truth information is available.

The extent of user intervention required may be minimised by selecting record features for user-defined classification that have the greatest potential to improve the classification technique and/or the results thereof. Hence, in examples of the disclosure, the classification system is advantageously configured to group, rank, and/or select ambiguous record features to output for user defined classification based on the relative improvement to the classification technique(s), and/or the results thereof, that their classification is likely to provide.

It is envisaged that the classification system will therefore improve the accuracy of the classification techniques and/or provide enhanced classification of input records, for example in a reduced number of iterations, and with fewer, or less extensive, user intervention.

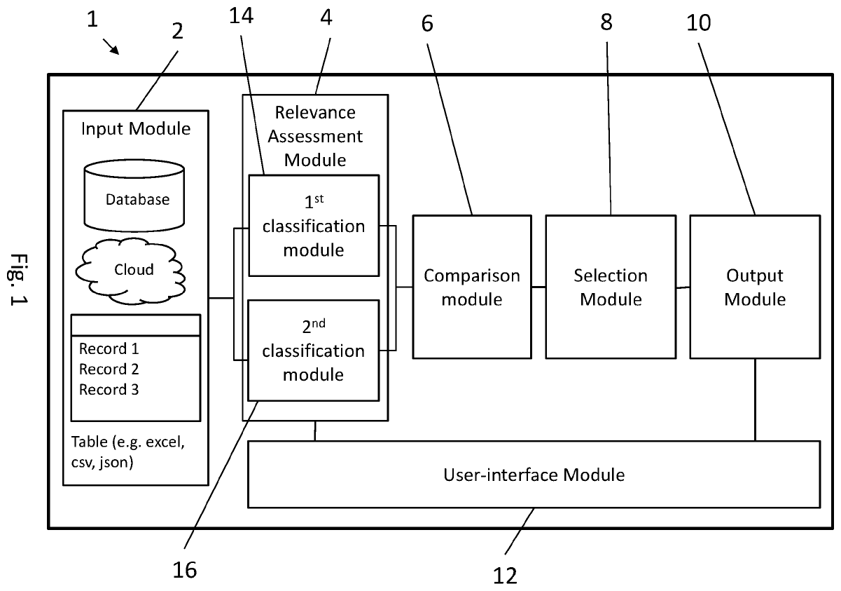

FIG. 1 schematically illustrates an example classification system 1 for determining the relevance of one or more input records to a classification scheme, such as a hierarchical structure.

The classification system 1 includes an input module 2, a relevance assessment module 4, a comparison module 6, a selection module 8, an output module 10 and a user-interface module 12. That is, in the described example six major functional elements, units or modules are shown. Each of these units or modules may be provided by suitable software running on any suitable computing substrate using conventional or customer processors and memory. Some or all of the units or modules may use a common computing substrate (for example, they may run on the same server) or separate substrates, or different combinations of the modules may be distributed between multiple computing devices.

The input module 2 is configured to receive, and/or store, the one or more input records. Each input record may include one or more record features that describe one or more subjects of the input record. To give an example, in the context of image classification, an input record may take the form of an image scene and the input record may include one or more record features, each defining a respective unclassified object in the image scene. In another example, an input record may include one or more record features that collectively describe a respective unclassified object in the image scene. In a further example, each input record may take the form of one or more strings of text and each string may form a respective record feature describing a respective subject of the input record. In other examples, the record features may include an attribute, or value, for a plurality of variables that describe at least one subject of the input record, for example.

The input module 2 is also configured to receive, and/or store, the classification scheme for classifying the one or more input records. The classification scheme includes a plurality of classification options that may each represent a respective subject, such as an object, event, or transaction, for example, or a respective feature of that subject. Hence, it shall be appreciated that the classification scheme may represent a taxonomy of objects, for example.

The classification scheme may take different forms in examples of the classification system 1 and may, for example, take the form of a hierarchical structure, such as a directed acyclic graph, a tree, or a forest of tress and/or directed acyclic graphs. Accordingly, the plurality of classification options may be arranged into successive tiers of classification, known as classification levels, within the classification scheme. With this arrangement, successive classification levels of the classification scheme may include increasingly granular classification options, representing more detailed subjects or more detailed features of said subjects. In this manner, the classification system 1 may be configured to determine the relevance of the input records at one or more levels of detail.

For this purpose, the input module 2 may include a memory storage module, such as a cloud storage system or a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The input module 2 may receive the classification scheme from any suitable source, including a memory storage device and/or a computing device. Similarly, the input module 2 may receive the one or more input records from any suitable source, including a memory storage device, a computing device and/or one or more data capture systems configured to generate the one or more input records. For example, the input module 2 may receive input records in the forms of a set of images for classification, which may be received from an image processing system.

The relevance assessment module 4 is configured to assess the relevance of the input records to the classification options of the classification scheme. For this purpose, the relevance assessment module 4 is configured to determine a set of scores, referred to as ‘relevance scores’ that are indicative of the relevance of the record features to the classification options of the classification scheme.

Each relevance score may indicate the relevance, or relative relevance, of a respective record feature to a respective classification option of the classifications scheme. For example, each relevance score may represent a probability that the respective record feature relates to the respective classification option. In this manner, differences between the relevance scores associated with respective record features can indicate that certain classification options are more or less relevant to the respective record features.

Advantageously, the relevance assessment module 4 is configured to determine the set of relevance scores based on first and second classification techniques. In this manner, the determined set of relevance scores includes various pairs of relevance scores. Each pair of relevance scores is associated with a respective record feature and a respective classification option and includes a first relevance score based on the first classification technique and a second relevance score based on the second classification technique. The association of each pair of relevance scores with a respective record feature and a respective classification option, means that each pair of relevance scores may be associated with the relevance of a single respective record feature, a plurality of respective record features from the same input record, or each record feature of an input record, with reference to a respective classification option.

Hence, in an example, the relevance assessment module 4 may be configured to determine each pair of relevance scores by comparing the respective record feature to the respective classification option, independently of any other record features. However, it shall be appreciated that the relevance assessment module 4 is not limited to such a configuration and, in other examples, one or more of the pairs of relevance scores may be determined by comparing a plurality of respective record features (considered in combination), or an input record (as a whole), to a respective classification option. Accordingly, where all, or a plurality of, record features of an input record collectively describe a respective subject, the relevance assessment module 4 may be configured to determine equivalent pairs of relevance scores associated with each of those record features and the respective classification option or a single pair of relevance scores associated with each of those record features and the respective classification option.

In order to determine the set of relevance scores, the relevance assessment module 4 may include a first classification module 14 and a second classification module 16, as shown in FIG. 1. The first classification module 14 determines the first relevance score of each pair based on the first classification technique. The second classification module 16 determines the second relevance score of each pair based on the second classification technique.

As shall become clear, the first and second classification modules 14, 16 use different classification techniques that may, for example, include one or more machine learning algorithms, rule-based algorithms, and/or look-up tables, for independently determining the respective first and second relevance scores. It shall be appreciated that the classification techniques may take different forms in dependence on the form or format of the input records to be classified.

To give an example, if each input record took the form of one or more strings of text, each forming a respective record feature, the classification technique may account for matches between keywords, values or measurements extracted from the respective record features, and any keywords, values or measurements associated with the respective classification options. To give another example, each input record may take the form of an image scene comprising one or more boundary boxes, each boundary box forming a respective record feature and defining a respective group of pixels that depicts a respective unclassified object. In this case, the classification technique may, for example, apply a trained set of filters that correspond to the respective classification options in order to determine the relevance or agreement between the pixels in each boundary box and the respective classification options. In an example, the classification system 1 may be configured to determine the first and second relevance scores for each classification option in the classification scheme, thereby providing a complete assessment of the relevance of the input records to the classification scheme.

In another example, the first and second classification modules 14, 16 may be configured to determine first and second relevance scores for selected ones of the classification options. For example, the relevance assessment module 4 may be configured to determine the first and second relevance scores for a plurality of classification options arranged at one or more desired classification levels of the classification scheme.

The comparison module 6 is configured to identify instances where the first and second classification techniques disagree. For example, the comparison module 6 may be configured to identify those record features for which the classification results differ between the first and second classification techniques.

The comparison module 6 may therefore be configured to compare the first and second relevance scores of each pair of relevance scores and to identify those record features that are associated with one or more divergent, disagreeing, or unmatched pairs of relevance scores, i.e. one or more pairs of relevance scores in which the first and second relevance scores differ, for example differing by more than a threshold amount.

As shall become clear, the comparison module 6 may identify such record features as ‘ambiguous record features’. The term refers to the ambiguous nature of such record features which demonstrates a limitation of the first and/or second classification techniques to accurately classify such record features.

As shall become clear, the comparison module 6 may be configured to use one or more methods for comparing the results of the first and second relevance scores and identifying the ambiguous record features.

The selection module 8 is configured to select one or more of the identified ambiguous record features, or one or more input records containing said ambiguous record features, to output for user-defined classification.

For the sake of clarity, if it is not possible, less efficient, or otherwise less desirable, for example, for a user to classify an ambiguous record feature independently of the other record features in the respective input record, then the selection module 8 may be configured to select the respective input record containing said ambiguous record feature instead and to output that input record for user-defined classification. Hence, it shall be appreciated that the ambiguous record features and/or the input record(s) that include the ambiguous record features may be selected for user-defined classification in the following examples.

In an example, the selection module 8 may select all of the ambiguous record features to output for user-defined classification.

In other examples, the selection module 8 may select some, but not all, of the ambiguous record features to output for user-defined classification. In which case, the selected ambiguous record features may be selected on the basis that the user-defined classification of the selected ambiguous record features has the greater potential to improve the classification technique(s), and/or the results thereof. For example, the selected ambiguous record features may demonstrate limitations in the capabilities of the first and/or second classification techniques that are considered more important in relation to the intended use of the classification system 1 than the other ambiguous record features.

For this purpose, the selection module 8 may be configured to evaluate the relative importance of the ambiguous record features, i.e. evaluating the relative criticality of the accurate classification of said ambiguous record features to the intended use of the classification system 1.

Accordingly, the selection module 8 may be configured to determine, or receive, one or more importance factors associated with each ambiguous record feature. Each importance factor may be associated with a single respective ambiguous record feature or the same importance factor may be associated with each one of a plurality of respective ambiguous record features. Each importance factor may be based on one or more variables that are indicative of the relative importance of accurately classifying the respective ambiguous record features, for example with respect to the intended use of the classification system 1.

As shall become clear, the selection module 8 may be configured to use one or more selection methods for selecting the ambiguous record features based on their associated importance factors, which may include methods for ranking the ambiguous record features and selecting ambiguous record features to output based on the rankings. The selection methods may additionally, or alternatively, include methods for determining ambiguous data groups, each comprising one or more similar or related ambiguous record features, and methods for selecting one or more ambiguous data groups to output.

To give an example, the selection module 8 may be configured to determine the ambiguous data groups based on one or more user inputs that define relationships between the record features and/or the input records.

Alternatively, or additionally, the selection module 8 may be configured to determine the ambiguous data groups based on one or more data processing methods, that may use clustering technique(s) and/or knowledge graph(s) that include relational data indicating relationships between the record features and/or the input records. For example, the selection module 8 may receive or otherwise determine a knowledge graph that integrates relational data into an ontology and the selection module 8 may apply a data processing algorithm to the knowledge graph to determine relational groupings of the record features and/or the input records, for example.

In this manner, the selection module 8 may be configured to select those ambiguous record features that are considered most important to the classification system 1, or the input records containing those ambiguous record features, for user-defined classification.

The output module 10 is configured to output the selected ambiguous record features, or the input records containing said ambiguous record features, to the user-interface module 12 for user-defined classification. In examples, the output module 10 may be configured to output the selected ambiguous record features, or the respective input records, individually, as groups of related record features, or as groups of related records, for user-defined classification.

The output module 10 may also be configured to output the convergent relevance scores associated with the other record features, or the other input records, to another system for further use and/or classification. In other words, non-ambiguous record features, or input records, which are associated with first and second relevance scores that agree, or match, may be output to another system. Additionally, or alternatively, those non-ambiguous record features, or input records, may be classified according to the convergent relevance scores.

The user-interface module 12 is configured to provide a human machine interface between the classification system 1 and a user, presenting the selected ambiguous record features, or the respective input records, in a suitable manner for receiving user-defined classification. For example, where one ambiguous record feature takes the form of a group of pixels depicting an unclassified object, the group of pixels may be presented to a user through the user-interface module 12 and the user-interface module 12 may be configured to receive suitable user inputs that provide ground truth information and/or classify the ambiguous record feature according to one or more classification options of the classification scheme. In another example, where one ambiguous record feature takes the form of a string of text describing a respective subject, the input record, or those ambiguous strings of text, may be presented to a user through the user-interface module 12 in a similar manner for the user to provide user inputs through the user-interface module 12 for providing ground truth information and/or classifying the ambiguous record feature.

The user-defined classifications may be used to correct the first and/or second relevance scores for the ambiguous record features. The user-defined classifications may additionally, or alternatively, be used to update the first and/or second classification techniques. For example, the first and/or second classification modules 14, 16 may be trained based on the user defined classification of the selected ambiguous record features so as to enhance the first and/or second classification techniques.

The technical benefit of the classification system 1 includes an efficiency gain through the reduction of the user intervention required to construct accurate classifications, and a computational improvement due to a reduction of the iterations required to classify the input records.

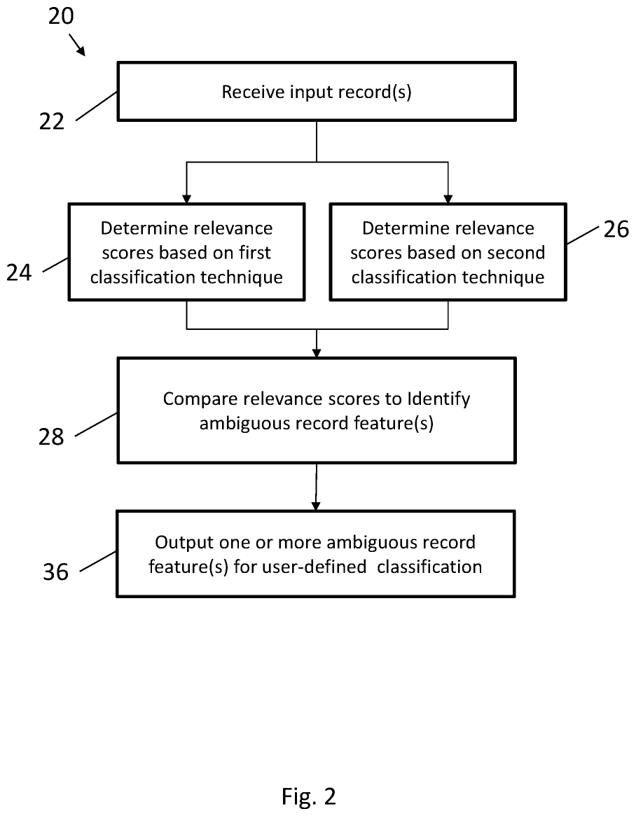

The operation of the classification system 1 shall now be described with additional reference to FIGS. 2 to 5.

FIG. 2 shows an example method 20 of operating the classification system 1 to classify one or more input records according to a classification scheme.

In step 22, the classification system 1 receives the one or more input records for comparison to the classification scheme.

For example, in step 22, one or more input records may be determined by one or more computing devices or data capture systems, for example, and those input record(s) may be transferred to the input module 2 of the classification system 1.

To give an example, in the context of image classification, an input record may take the form of an image scene and the input record may include one or more record features, each defining a respective boundary box containing a respective group of pixels that depict an unclassified object in the image scene. For example, a first record feature may define a respective boundary box in the image scene containing a group of pixels that depict a first unclassified object, such as a building. A second record feature may define another boundary box in the image scene containing a group of pixels that depict a second unclassified object, such as a car.

The classification scheme may take the form of a tree that represents a taxonomy of objects. The tree may include classification options representing buildings and cars, for example, amongst other objects. The classification scheme may also include more detailed classification levels, for example with more detailed classification levels including classifications options for respective brands of cars and/or types of buildings, such as a semi-detached building, a high-rise building, or a bungalow, for example.

It shall be appreciated that this example is not intended to be limiting on the scope of the classification system 1 though and, in other examples, the input records and/or the classification scheme may take other suitable forms.

In steps 24 and 26, the classification system 1 determines pairs of relevance scores for each input record based on the first and second classification techniques. In particular, the classification system 1 may determine various pairs of relevance scores, with each pair of relevance scores being associated with a respective record feature and a respective classification option. Each of the determined pairs of relevance scores includes a first relevance score based on the first classification technique and a second relevance score based on the second classification technique.

Hence, in step 24, the first classification module 14 may determine the first relevance score of each pair of relevance scores based on the first classification technique. In this example, the first classification technique may include a machine learning algorithm for determining the relevance of each record feature to each classification option. Such machine learning algorithms are known in the art and it shall be appreciated that the first relevance score may therefore be determined according to a known image classification technique that may include a neural network for learning combinations of pixels associated with respective objects. This example is not intended to be limiting on the classification system 1 though and, in other examples, the first classification technique may take other suitable forms.

In step 24, the first classification module 14 may therefore apply the first classification technique and determine a relatively high first relevance score for the first record feature with respect to the classification option representing a car and a similarly high first relevance score for the second record feature with respect to the classification option representing a building. At a more detailed classification level, the first classification module 14 may determine a relatively high first relevance score for the second record feature with respect to a classification option representing a semi-detached building but determine a relatively low first relevance score for the second record feature with respect to a classification option representing a bungalow. In this manner, the first relevance scores may indicate that the second record feature is more relevant to the classification option representing the semi-detached building, than the classification option that represents the bungalow.

In step 26, the second classification module 16 may determine the second relevance score of each pair of relevance scores based on the second classification technique. In this example, the second classification technique may include another (distinct) machine learning algorithm that may, for example, have been trained to learn different combinations of pixels associated with respective objects and thereby to determine the second relevance scores for each record feature. Again, this example is not intended to be limiting on the classification system 1 though and, in other examples, the second classification technique may take other suitable forms.

In step 26, the second classification module 16 may therefore determine relatively high second relevance scores for the first and second record features with respect to the classification options representing the car and the building, respectively. However, the second classification module 16 may determine a relatively low second relevance score for the second record feature with respect to the classification option representing the semi-detached building and determine a relatively high second relevance score for the second record feature with respect to the classification option representing the bungalow.

Hence, although the first and second classification techniques agree that the first record feature is relevant to cars and that the second record feature is relevant to buildings, the first and second classification techniques may disagree as to whether the second record feature is more relevant to a semi-detached building or a bungalow, as shall become clear.

In step 28, the classification system 1 compares the first and second relevance scores of each pair of relevance scores to identify any ambiguous record features.

It shall be appreciated that the comparison module 6 may use one or more methods of comparison to identify the ambiguous record features.

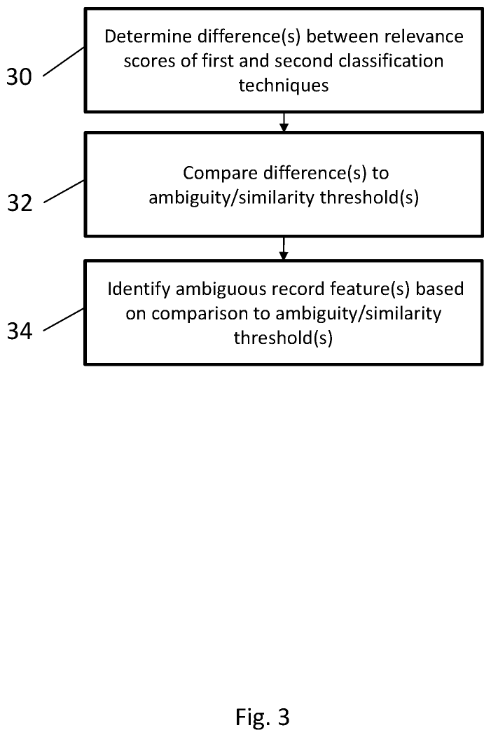

For example, the comparison module 6 may compare the first and second relevance scores of each pair of relevance scores to identify any ambiguous record features, where each ambiguous record feature is associated with at least one divergent pair of relevance scores. For example, the method 20 may include sub-steps 30 to 34 for identifying the ambiguous record features, as shown in FIG. 3.

Sub-steps 30 to 34 describe the process of comparing a pair of relevance scores determined for a respective classification option in order to identify an ambiguous record feature. However, it shall be appreciated that sub-steps 30 to 34 may be executed for each pair of relevance scores having a first relevance score and a second relevance score determined for a respective record feature and a respective classification option in order to comprehensively identify the ambiguous record features within the input record(s).

In sub-step 30, the comparison module 6 may compare the first and second relevance scores to determine a difference between the first and second relevance scores.

In sub-step 32, the comparison module 6 may compare the determined difference between said first and second relevance scores to a threshold, such as an ambiguity threshold. For example, the comparison module may compare an absolute value of the determined difference to an ambiguity threshold. The ambiguity threshold may depend on at least one of: the respective classification option; and/or the classification level of the respective classification option within the classification scheme. For example, the ambiguity threshold may be lower for classification options in a higher classification level, where differences between the classification options are more significant (e.g. between the classification options representing buildings and cars), than for classification options in a lower classification level (such as the classification level that includes respective types of buildings).

Where the ambiguity threshold depends on the respective classification option, and/or the classification level of the respective classification option within the classification scheme, it shall be appreciated that the ambiguity threshold may be configured to control the sensitivity of the comparison module 8 to detecting ambiguous record features based on different classification options. For example, if a record feature is associated with a pair of relevance scores for an important classification option (such as a classification option in a high classification level), the ambiguity threshold may be relatively low, so that a relatively small difference between the first and second relevance scores causes the comparison module 8 to identify the record feature as an ambiguous record feature.

In sub-step 34, the comparison module 6 may identify the ambiguous record features based on the comparison to the threshold. For example, if the threshold is an ambiguity threshold, as described above, and the determined difference between the first and second relevance scores exceeds the ambiguity threshold, the comparison module 6 may determine that the respective record feature is an ambiguous record feature.

In this manner, the comparison module 8 may identify each ambiguous record feature, in dependence on the determined difference between at least one of the respective pairs of relevance scores exceeding the respective ambiguity threshold.

In another example, the comparison module 8 may be configured to identify each ambiguous record feature in dependence on the determined difference between selected ones of the respective pairs of relevance scores exceeding the respective ambiguity thresholds. For example, in sub-step 34, the comparison module 8 may identify a record feature as an ambiguous record feature if: i) the determined difference between the respective pair of relevance scores exceeds the respective ambiguity threshold; and ii) the respective classification option is in a high classification level of the classification scheme, for example in a classification level above a threshold level. Alternatively, the comparison module 8 be configured to determine the highest classification level at which the determined difference between at least one respective pair of relevance scores exceeds the respective ambiguity threshold for a respective classification option at that classification level and to identify that record feature as an ambiguous record feature in dependence on that highest classification level. For example, in dependence on that classification level being above a threshold level in the classification scheme. In this manner, the comparison module 8 may not identify a record feature as an ambiguous record feature if the determined difference between the respective pair of relevance scores exceeds the respective ambiguity threshold, but the respective classification option is in a low classification level of the classification scheme, for example below the threshold level.

Returning to the method 20, shown in FIG. 2, in step 36, the classification system 1 outputs one or more of the ambiguous record features for user-defined classification.

For example, the selection module 8 may select one or more of the ambiguous record features, or one or more of the respective input records containing said ambiguous records, and the output module 10 may output the selected ambiguous record features or the selected input records for user-defined classification.

It shall be appreciated that the selection module 8 may use one or more methods for making the selection, including methods of grouping ambiguous record features, or the respective input records, based on their similarity, and methods of ranking the ambiguous record features, or the respective input records. For example, the ambiguous record features, or the respective input records, may be ranked based on the relative criticality of their classification to the intended use of the classification system 1.

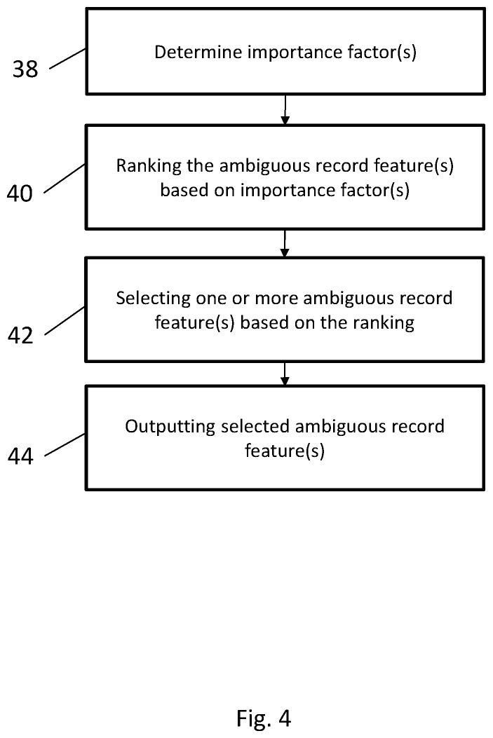

In an example, the method 20 may include sub-steps 38 to 44 for ranking, selecting and outputting the ambiguous record features for user-defined classification, as shown in FIG. 4.

In sub-step 38, the selection module 8 may determine one or more importance factors based on one or more variables that are indicative of the relative importance of accurately classifying the respective ambiguous record features, for example with respect to the intended use of the classification system 1.

It shall be appreciated that the one or more variables may take various suitable forms for this purpose. The selection module 8 may determine the importance factors, using one or more rule-based algorithms, and/or look-up tables that may store pre-determined importance factors for respective values, or attributes, of prescribed variables. In this manner, the selection module 8 may determine a numerical value or weighting, for example on a binary, or n-ary scale, that is indicative of the relative importance of the accurate classification of the respective ambiguous record feature to the intended use of the classification system 1.

To give an example, in sub-step 38, the selection module 8 may determine, or receive, an importance factor associated with each ambiguous record feature. For each ambiguous record feature, the importance factor may be based on the respective classification option having the divergent pair of relevance scores. The importance factor may additionally, or alternatively, be based on the classification level of that classification option. In this manner, the importance factor may vary in dependence on the relative criticality of accurate relevance scores for that classification option, or that classification level, to the intended use of the classification system 1. Hence, whilst it may be important for the intended use of the classification system 1 to be able to accurately determine the relevance of an ambiguous record feature to classification options representing buildings or cars, it may be less important for the intended use of the classification system 1 to be able to accurately determine the relevance of an ambiguous record feature to classification options representing the style of the building. This would be reflected in the relative importance factors.

In another example, for each ambiguous record feature, the importance factor may additionally, or alternatively, be based on a confidence score associated with one, or each, of the first and second relevance scores in the divergent pair of relevance scores. For example, the relevance assessment module 4 may determine confidence scores for each of the first and second relevance scores, which may be received by the selection module 8. Each confidence score may be indicative of the relative uncertainty in the respective first or second relevance score, with a high confidence score indicating that there is low uncertainty in the determined relevance score, whilst a low confidence score indicates that there is high uncertainty in the determined relevance score. The selection module 8 may, for example, be configured for greater sensitivity to one classification technique than the other. For example, if the first classification technique is considered more important, the selection module 8 may determine a relatively high importance factor for an ambiguous record feature where the confidence score of the first relevance score is relatively low. This may be the case even if a confidence score of the second relevance score is relatively high. Such a configuration would help to indicate ambiguous record features where the first classification technique is inaccurate, thus pointing out ambiguous record features where the user intervention would be more important.

In sub-step 40, the selection module 8 may determine a ranking based on the one or more importance factors that ranks the ambiguous record features and/or the input records containing the ambiguous record features.

For example, the selection module 8 may determine the ranking based on the relative magnitude of the importance factor associated with each ambiguous record feature or based on a sum, or a weighted sum, of the importance factors determined for the ambiguous record features in each input record.

In sub-step 42, the selection module 8 may select one or more of the ambiguous record features to output for user-defined classification based on the ranking.

It shall be appreciated that the selection module 8 may use one or more methods for making the selections. To give an example, the selection module 8 may be configured to select the top n-ranked ambiguous record features where ‘n’ is an integer that may be predetermined and/or reconfigurable. In another example, the selection module 8 may be configured to select the top m-ranked input record(s) and/or the top n-ranked ambiguous record features within those input record(s), where ‘n’ and ‘m’ are integers that may be predetermined and/or reconfigurable.

In this manner, the selection module 8 may therefore select one or more of the ambiguous record features to output for user-defined classification, whether selected in the form of individual selections of ambiguous record features or individual selections of input records containing ambiguous record features.

In sub-step 44, the output module 10 may output the selected ambiguous record features to the user-interface module 12 for user-defined classification. The selected ambiguous record features may be output as individual record features or as record features of the selected input records.

For example, the output module 10 may output the selected ambiguous record features, or input record(s) comprising said ambiguous record features, along with the respective classification option(s) for which the first and second classification techniques produced the divergent pair of relevance scores. This may allow a user to select the correct classification option for said ambiguous record features/input records or otherwise provide suitable ground truth information indicating the relevance of the ambiguous record features/input records to the classification options of the classification scheme.

The output module 10 may also output the convergent relevance scores associated with the other record features, or the other input records, to another system for further use and/or classification. In other words, non-ambiguous record features, or input records, which are associated with first and second relevance scores that agree, or match, may be output to another system. Additionally, or alternatively, those non-ambiguous record features, or input records, may be classified according to the convergent relevance scores.

In this manner, the classification system 1 is able to classify a set of input records according to a classification scheme and to identify and output a subset of input record/record features that are considered ambiguous for user-defined classification.

The technical benefit of the classification system 1 includes an efficiency gain through the reduction of the user intervention required to construct accurate classifications, and a computational improvement due to a reduction of the iterations required to classify the input records.

Many modifications may be made to the above-described example without departing from the scope of the appended claims.

In another example, the method 20 may be substantially as described in any previous example. However, in step 36, the method 20 may select the ambiguous record features, or the respective input records containing said ambiguous record features, to output for user-defined classification, without ranking the ambiguous record features, or the respective input records. Instead, the method 20 may determine the importance factors for each ambiguous record features, or the respective input records containing those ambiguous record features, as described in sub-step 38, and select the ambiguous record features, or the respective input records, to output for user defined classification by comparison of the determined importance factors to a respective threshold.

For example, the selection module 8 may compare the importance factor determined for each ambiguous record feature to a respective threshold and, if the importance factor exceeds the threshold, the selection module 8 may select that ambiguous record feature, or the respective input record, to output for user defined classification. The classification system 1 may then output that ambiguous record feature, or that input record, to the user-interface module 12, substantially as described in sub-step 44, for user defined classification.

In another example, the method 20 may be substantially as described in the previous examples. However, in step 36, the method 20 may be further configured to determine a plurality of ambiguous data groups (each comprising one or more ambiguous record features) in order to select the ambiguous record features to output for user-defined classification. Each ambiguous data group may group ambiguous record features, or the input records containing said ambiguous record feature, together based on their similarity.

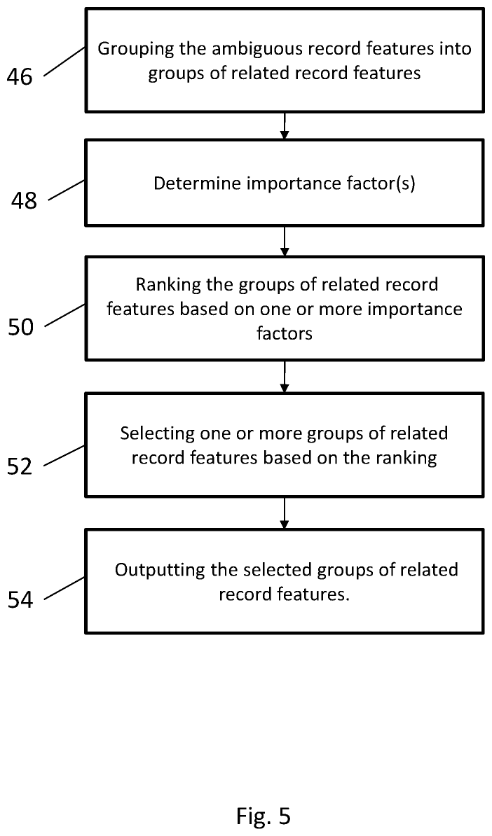

Hence, in step 36, the method 20 may include sub-steps 46 to 54 for grouping, ranking, selecting and outputting the ambiguous record features for user-defined classification, as shown in FIG. 5.

In sub-step 46, the selection module 8 may determine the ambiguous data groups.

In an example, the selection module 8 may determine the ambiguous data groups based on a set of pre-programmed, or user-defined, rules for identifying similar, related, or corresponding record features/input records.

To give an example, each ambiguous data group may be determined on the basis that the ambiguous record features of that group are each associated with respective divergent pairs of relevance scores for the same, or similar, classification options. For example, if two or more ambiguous record features are each associated with a divergent pair of relevance scores with respect to the classification option representing buildings, then those ambiguous record features, or the respective input records, may be grouped together in an ambiguous data group.

To give another example, each ambiguous data group may be determined in dependence on selecting one or more corresponding record features of the input records. For example, if two or more input records include record features that are determined to be relevant to a first classification option, such as buildings, but the input records each include one or more ambiguous record features being associated with a divergent pair of relevance scores with respect to more detailed classification options, such as windows or doors, then those input records may be grouped together in an ambiguous data group. In this manner, the selection module 8 may effectively determine, or receive, a set of record features for determining each ambiguous data group and apply filters corresponding to the selected features to determine each ambiguous data group.

In a further example, the selection module 8 may determine the ambiguous data groups using one or more data mining techniques, which may include a clustering technique and/or a knowledge graph. For example, in sub-step 46, the selection module 8 may be configured to determine a knowledge graph based on the input records, or the ambiguous record features, using one or more graph mapping algorithms configured to map the record features and associated classification data, such as the determined first and second relevance scores, into a knowledge graph.

The knowledge graph organises the information in a manner that retains semantic knowledge, for example including similarity distance scores indicating the similarity of the classification data and the record features. Knowledge graphs are well known in the art of graph theory and are not discussed in more detail here to avoid obscuring the contribution of the present disclosure. Nonetheless, the knowledge graph may be suitable for logically deriving relational data that indicates that certain record features are related to one another. Hence, the selection module 8 may apply one or more semantic reasoning algorithms or clustering techniques to the knowledge graph to determine the ambiguous data groups.

In sub-step 48, the selection module 8 may determine, or receive, an importance factor associated with each ambiguous record feature or each input record containing an ambiguous record feature. The importance factor may be substantially as described in sub-step 38. Additionally, or alternatively, the importance factor may be based on the respective ambiguous data group. For example, the importance factor may be determined based on a size of the respective ambiguous data group. For example, the importance factors may be determined based on a count of the number of ambiguous record features or input records in each ambiguous data group.

In-sub-step 50, the selection module 8 may determine a ranking based on the importance factors that ranks the ambiguous data groups.

For example, the selection module 8 may determine that the ambiguous data group having the most ambiguous record features, or input records, is the highest ranking ambiguous data group and that the ambiguous data group having the fewest ambiguous record features, or input records, is the lowest ranking ambiguous data group. In an example, the selection module 8 may further determine the ranking based on a sum or a weighted sum of the importance factors determined for each ambiguous record features or input record in each ambiguous data group. In an example, the selection module 8 may also determine a ranking of the ambiguous record features, or the input records, within each ambiguous data group based on the importance factors, substantially as described in sub-step 40.

In sub-step 52, the selection module 8 may select one or more of the ambiguous data groups, or one or more ambiguous record features, or input record(s), from one or more of the ambiguous data groups, to output for user-defined classification based on the ranking.

It shall be appreciated that the selection module 8 may use one or more methods for making the selections. To give one non-limiting example, the selection module 8 may be configured to select the top m-ranked ambiguous data groups, where ‘m’ is an integer that may be predetermined and/or reconfigurable. The selection module 8 may further select all of the ambiguous record features and/or input records in those selected ambiguous data groups or a selection thereof according to a method described in sub-step 42, for example.

In sub-step 54, the output module 10 may output the selected ambiguous record features, or input record(s) comprising said ambiguous record features, to the user-interface module 12 for user-defined classification.

For example, the output module 10 may output each of the selected ambiguous data groups for user-defined classification. Each ambiguous data group may be output along with the shared classification option(s) for which the first and second classification techniques produced divergent pair of relevance scores, for example.

In this manner, the user-interface module 12 may present a user with an example one of the input records or ambiguous record features in the output ambiguous data group and the user may be able to provide one or more user inputs at the user-interface module 12 to select the correct classification option for each ambiguous record features/input record in that ambiguous data group.

In sub-step 54, the output module 10 may also output the convergent relevance scores associated with the non-ambiguous record features, or input records, to another system for further use and/or classification. Additionally, or alternatively, those non-ambiguous record features, or input records, may be classified according to the convergent relevance scores.

The technical benefit of the classification system 1 includes a further efficiency gain through the further reduction of the user intervention required to construct accurate classifications, and a computational improvement due to a reduction of the iterations required to classify the input records.

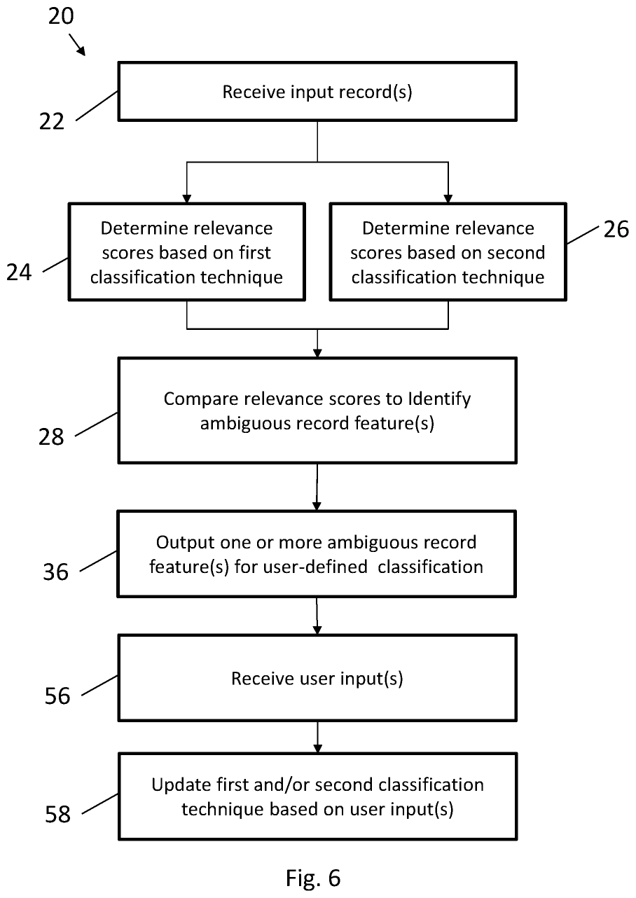

In another example, shown in FIG. 6, the method 20 may be further configured to update the first and/or second classification techniques based on the user-defined classifications, for example as part of a training process for said classification technique.

For this purpose, the method 20 may be substantially as described in any of the previous examples, however the method 20 may further include steps 56 and 58.

In step 56, the classification system 1 receives one or more user inputs providing user-defined classifications for the output ambiguous record features or input records.

For example, the user-interface module 12 may have output the selected ambiguous record features, input record(s), or ambiguous data groups along with the respective classification option(s) for which the first and second classification techniques produced the divergent pair of relevance scores.

In step 56, the user-interface module 12 may therefore receive one or more inputs from a user for each ambiguous record feature, input record, or ambiguous data group, providing a user-defined classification of the ambiguous record feature, input record, or ambiguous data group. Such user-defined classification may, for example provide a relevance score for one or more classification options, such as the respective classification option(s) for which the first and second classification techniques produced the divergent pair of relevance scores.

The user-defined classifications may therefore be output with the ambiguous record features, input record(s), or ambiguous data groups, to form a complete set of record features and associated relevance scores in combination with the convergent relevance scores associated with the non-ambiguous record features, or input records. The record features, or input records, may therefore be classified according to the relevance scores.

In step 58, the classification system 1 updates the first and/or second classification techniques based on the user-defined classifications.

For example, the user-interface module 12 may output the user-defined classifications to the relevance assessment module 4 and the relevance assessment module 4 may be configured to determine which of the first and/or second classification techniques produced an incorrect relevance score for a respective ambiguous record feature. Based on this determination, the relevance assessment module 4 may be configured to train the erroneous classification technique based on the ground truth information provided by the user-defined classification.

In this manner, the accuracy and/or classification capabilities of the classification system 1 may be iteratively improved with minimal user intervention.

1. A computer-implemented method for classifying input record data by relevance to classification options of a classification scheme, the input record data comprising a plurality of input records, each input record comprising one or more record features, the method comprising:
receiving a set of relevance scores based on first and second classification techniques, the set of relevance scores comprising pairs of relevance scores, each pair of relevance scores being associated with a respective record feature and a respective classification option and comprising a first relevance score obtained by the first classification technique and a second relevance score obtained by the second classification technique, each of the first and second relevance scores being indicative of a relevance of the respective record feature to the respective classification option;
determining one or more ambiguous record features of the record features by comparing the first and second relevance scores of each pair of relevance scores, wherein it is determined whether each respective record feature is an ambiguous record feature in dependence on a difference between the first and second relevance scores of at least one of the respective pairs of relevance scores associated with that record feature;
determining an importance factor associated with each determined ambiguous record feature based on one or more variables indicative of the relative importance of accurately classifying that ambiguous record feature;
selecting one or more of the ambiguous record features to output based on their associated importance factors; and
outputting the selected ambiguous record features for user-defined classification.

2. A method according to claim 1, wherein determining whether each respective record feature is an ambiguous record feature comprises comparing the difference between the first and second relevance scores of at least one of the respective pairs of relevance scores associated with that record feature to an ambiguity threshold.

3. A method according to claim 1, wherein, for each importance factor, the one or more variables include:
the respective classification option for each pair of relevance scores that the ambiguous record feature determination depends on; and/or
a hierarchical position, within the classification scheme, of that classification option.

4. A method according to claim 3, wherein, for each importance factor, the one or more variables include:
a weighting associated with the respective classification option for each pair of relevance scores that the ambiguous record feature determination depends on; and/or
a weighting associated with the hierarchical position, within the classification scheme, of that classification option.

5. A method according to claim 1, wherein, for each importance factor, the one or more variables include:
a respective confidence score associated with the first relevance score of each pair of relevance scores that the ambiguous record feature determination depends on; and/or
a respective confidence score associated with the second relevance score of each pair of relevance scores that the ambiguous record feature determination depends on.

6. A method according to claim 1, wherein selecting the one or more ambiguous record features to output for user-defined classification comprises:
determining a relative ranking of the ambiguous record features based on their associated importance factors; and
selecting one or more of the ambiguous record features to output for user-defined classification based on the ranking.

7. A method according to claim 1, wherein selecting the one or more ambiguous record features to output for user-defined classification comprises:
determining a plurality of ambiguous data groups, each ambiguous data group comprising related ones of the ambiguous record features; and
selecting one or more of the ambiguous data groups to output for user-defined classification based on the importance factors associated with the ambiguous record features of that ambiguous data group.

8. A method according to claim 7, wherein selecting the one or more ambiguous record features to output for user-defined classification further comprises determining a relative ranking of the ambiguous data groups based on the importance factors associated with the ambiguous record features of each ambiguous data group; and
wherein the selection of the ambiguous data groups to output for user-defined classification is based on the ranking.

9. A method according to claim 7, wherein determining the ambiguous data groups comprises:
determining a knowledge graph that models the relevance of the one or more ambiguous record features to one another; and
applying a clustering technique to the knowledge graph.

10. A method according to claim 7, wherein, for each importance factor, the one or more variables include a measure of the relative size of the respective ambiguous data group for the respective ambiguous record feature.

11. A method according to claim 1, further comprising:
receiving a plurality of input records, each input record comprising one or more record features; and
determining the set of relevance scores based on a first classification technique and a second classification technique.

12. A method according to claim 11, further comprising updating the first and/or second classification techniques based on the user-defined classification of the selected one or more ambiguous record features.

13. A method according to claim 11, wherein the first classification technique is a machine learning technique.

14. A method according to claim 13, wherein the first classification technique is updated by training the machine learning technique based on the user defined classification of the selected one or more ambiguous record features.

15. A non-transitory, computer-readable storage medium having instructions stored thereon that, when executed by a computer, cause the computer to carry out the method of claim 1.

16. A classification system for classifying input record data by relevance to classification options of a classification scheme, the input record data comprising a plurality of input records, each input record comprising one or more record features, the classification system comprising:
a comparison module configured to:
receive a set of relevance scores based on first and second classification techniques, the set of relevance scores comprising pairs of relevance scores, each pair of relevance scores being associated with a respective record feature and a respective classification option and comprising a first relevance score obtained by the first classification technique and a second relevance score obtained by the second classification technique, each of the first and second relevance scores being indicative of the relevance of the respective record feature to the respective classification option; and
determine one or more ambiguous record features of the record features by comparing the first and second relevance scores of each pair of relevance scores, wherein it is determined whether each respective record feature is an ambiguous record feature in dependence on a difference between the first and second relevance scores of at least one of the respective pairs of relevance scores associated with that record feature;
a selection module configured to:
determine an importance factor associated with each determined ambiguous record feature based on one or more variables indicative of the relative importance of accurately classifying that ambiguous record feature; and
select one or more of the ambiguous record features to output based on their determined importance factors; and
an output module configured to output the selected ambiguous record features for user-defined classification.

17. A classification system according to claim 16, wherein the selection module is configured to select the ambiguous record features to output for user-defined classification by:
determining a relative ranking of the ambiguous record features based on their associated importance factors; and
selecting one or more of the ambiguous record features to output for user-defined classification based on the ranking.

18. A classification system according to claim 16, wherein the selection module is configured to select the one or more ambiguous record features to output for user-defined classification by:
determining a plurality of ambiguous data groups, each ambiguous data group comprising related ones of the ambiguous record features; and
selecting one or more of the ambiguous data groups to output for user-defined classification based on the importance factors associated with the ambiguous record features of that ambiguous data group.

19. A classification system according to claim 18, wherein the selection module is configured to select one or more of the ambiguous data groups to output for user-defined classification by:
determining a relative ranking of the ambiguous data groups based on the importance factors associated with the ambiguous record features of each ambiguous data group; and
selecting one or more of the ambiguous data groups to output for user-defined classification based on the ranking.

20. A classification system according to claim 1, further comprising:
an input module configured to receive a plurality of input records, each input record comprising one or more record features;
a relevance assessment module configured to determine the set of relevance scores based on a first classification technique and a second classification technique; and
a user-interface module configured to receive one or more user inputs and to determine the user-defined classification of each ambiguous record feature received from the output module based on the one or more user inputs, and to output the user-defined classification of each ambiguous record feature to the relevance assessment module;
the relevance assessment module being further configured to update the first and/or second classification technique based on the user-defined classification of each ambiguous record feature.

21-22. (canceled)
